(19) United States
(12) Patent Application Publication
(10) Pub. No.: US 2012/0245242 A1
(43) Pub. Date: Sep. 27, 2012

(54) POLYURETHANE PREPOLYMERS

(75) Inventors: Evelyn Peiffer, Leverkusen (DE); Mathias Matner, Neuss (DE)

(73) Assignee: Bayer Intellectual Property GmbH, Monheim (DE)

(21) Appl. No.: 13/514,782

(22) PCT Filed: Dec. 6, 2010
(86) PCT No.: PCT/EP2010/068978

§ 371 Date: Jun. 8, 2012

(30) Foreign Application Priority Data
Dec. 9, 2009 (DE) 10 2009 057 584.7

(51) Int. Cl. C08G 71/04; C09J 175/04; C09D 175/04

(52) U.S. Cl. 521/154; 528/41; 524/588

(57) ABSTRACT

The invention relates to polyurethane prepolymers, to a method for the production thereof, and the use thereof as binding agents for adhesives, coatings, or foams.

The present invention relates to polyurethane prepolymers, to a process for their preparation, and to their use as binders for adhesives, coatings or foams.

Alkoxysilane-functional polyurethanes which crosslink via a silane polycondensation have been known for a long time. An overview article on this subject is to be found, for example, in “Adhesives Age” April 1995, page 30 ff (authors: Ta-Min Feng, B. A. Waldmann). Such alkoxysilane-terminated, moisture-curing one-component polyurethanes are increasingly being used as flexible coating, sealing and adhesive compositions in construction and in the automotive industry.

Such alkoxysilane-functional polyurethanes can be prepared according to U.S. Pat. No. 3,627,722 or DE-A 1 745 526 by, for example, reacting polyether polyols with an excess of polyisocyanate to give an NCO-containing prepolymer, which is then in turn reacted further with an amino-functional alkoxysilane.

Publications EP-A 0 397 036, DE-A 19 908 562 (corresponding to EP-A 1 093 482) and US-A 2002/0100550 describe further different methods of preparing alkoxysilane-terminated polymers. According to those specifications, high molecular weight polyethers having an average molecular weight of 4000 g/mol or greater are used in each case.

All these alkoxysilane-terminated systems form, after curing, flexible polymers having relatively low strength and high breaking elongation. DE-A 1 745 526 describes tensile strengths in the range from 3.36 kg/cm² to 28.7 kg/cm² for polyoxypropylene glycol-based polymers. Strengths that are sufficiently high for structural bonding are achieved only with crystallising polycaprolactones.

However, such systems are very highly viscous or solid at room temperature and can therefore only be processed in the warm state.

Accordingly, the field of use of the above-mentioned applications is limited on the one hand to sealing materials and flexible adhesives and on the other hand to highly viscous or solid systems which can only be processed in the warm state.

The object underlying the present invention was, therefore, to provide alkoxysilane-terminated polyurethanes that are liquid at room temperature and achieve a high cohesive strength after curing, so that they can be used to formulate adhesives permitting structural bonding.

It has now been found that such alkoxysilane-terminated polyurethanes can be prepared by first producing an NCO prepolymer from 2,4′-methylenediphenyl diisocyanate (2,4′-MDI), optionally in admixture with other polyisocyanates, and a mixture of compounds having groups reactive towards isocyanates. The mixture of compounds having groups reactive towards isocyanates thereby contains compounds having a molecular weight ≦2000 g/mol in an amount of at least 50 wt. %. The resulting NCO prepolymer is then modified with an isocyanate-reactive alkoxysilane in a second step.

The invention accordingly provides polymers modified with alkoxysilane groups, obtainable by reacting:
a) an isocyanate-functional prepolymer which contains structural units of the general formula (I)

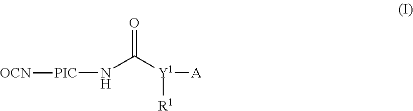

wherein
PIC represents a radical, reduced by the isocyanate groups, of 2,4′-methylenediphenyl diisocyanate (2,4′-MDI) or of a combination of 2,4′-methylenediphenyl diisocyanate with another polyisocyanate, wherein the proportion of 2,4′-methylenediphenyl diisocyanate is at least 50 wt. %, in each case based on the polyisocyanate component (component B),
Y¹ represents nitrogen, oxygen or sulfur,
R¹ represents either a free electron pair or hydrogen or any desired organic radical,
A represents a radical, reduced by the isocyanate-reactive groups, of an isocyanate-reactive polymer which is composed of polyether polyols, polyester polyols, polycarbonate polyols or polytetrahydrofuran polyols which are linked together in any desired sequence, that is to say blockwise, alternately or randomly, via the structural element of the formula

—Y²—(C═O)—NH—PIC—NH—(C═O)—Y¹(R¹)—,
wherein Y¹ and Y² independently of one another represent nitrogen, oxygen or sulfur, derived from the polyisocyanates B, wherein all or some of the terminal groups of those substructures can also be the corresponding thio compounds or amine derivatives, wherein
from 50 to 100 wt. % are substructures A1 having a mean molecular weight (Mn) of from 200 g/mol to 2000 g/mol and
from 0 to 50 wt. % are substructures A2 having a mean molecular weight (Mn) of more than 2000 g/mol,
and wherein A overall has a mean functionality of from 2 to 4,
with
b) an isocyanate-reactive alkoxysilane compound (component C) of the general formula (II):

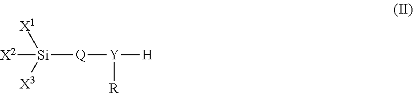

wherein
X¹, X² and X³ are identical or different alkoxy or alkyl radicals, which can also be bridged, but wherein at least one alkoxy radical must be present on each Si atom,
Q is a difunctional linear or branched aliphatic radical,
Y represents nitrogen or sulfur,
R represents either a free electron pair or hydrogen or any desired organic radical.

The reaction of a) with b) can take place in a ratio of from 0.8:1.0 to 1.3:1.0 (NCO:Y—H).

The compounds according to the invention are non-crystallising substances that are liquid at room temperature and have a number-average molecular weight of less than 7000 g/mol, preferably less than 5000 g/mol, and a viscosity of less than 1000 Pas at 23° C., preferably with a viscosity of less than 500 Pas at 23° C., particularly preferably with a viscosity of less than 100 Pas at 23° C.

The mixture of isocyanate-reactive compounds (component A) consists of from 50 to 100% of an isocyanate-reactive compound (A1) having from 2 to 4 isocyanate-reactive groups and a number-average molecular weight of from 200 g/mol to 2000 g/mol, and from 0 to 50% of an isocyanate-reactive compound (A2) having from 2 to 4 isocyanate-reactive groups and a number-average molecular weight of more than 2000 g/mol, wherein both A1 and A2 can each consist of combinations of compounds having isocyanate-reactive groups, provided those compounds fall within the above-described limits in respect of the molecular weight.

There can be used as component A any compounds known to the person skilled in the art that contain isocyanate-reactive groups and have a functionality, in the mean, of at least two. These can be, for example, higher molecular weight isocyanate-reactive compounds such as polyether polyols, polycarbonate polyols, polyester polyols as well as polythioether polyols. Preferably, such isocyanate-reactive compounds have a mean functionality of from 2 to 4, preferably from 2 to 3.5 and particularly preferably from 2 to 3.

Polyether polyols are preferably used. These are obtainable in a manner known per se by alkoxylation of suitable starter molecules with base catalysis or using double metal cyanide compounds (DMC compounds). Suitable starter molecules for the preparation of polyether polyols are molecules having at least two elemental hydrogen bonds reactive towards epoxides, or arbitrary mixtures of such starter molecules.

Particularly suitable polyether polyols are those of the above-mentioned type having a content of unsaturated end groups of less than or equal to 0.02 milliequivalents per gram of polyol (meq/g), preferably less than or equal to 0.015 meq/g, particularly preferably less than or equal to 0.01 meq/g (method of determination ASTM D2849-69).

This is described, for example, in U.S. Pat. No. 5,158,922 (e.g. Example 30) and EP-A 0 654 302 (p. 5, 1. 26 to p. 6, 1. 32).

Suitable starter molecules for the preparation of polyether polyols are, for example, simple, low molecular weight polyols, water, ethylene glycol, 1,2-propanediol, 2,2-bis(4-hydroxyphenyl)propane, 1,3-propylene glycol and 1,4-butanediol, 1,6-hexanediol, neopentyl glycol, 2-ethyl-1,3-hexanediol, trimethylolpropane, glycerol, pentaerythritol, sorbitol, organic polyamines having at least two N—H bonds, such as, for example, triethanolamine, ammonia, methylamine or ethylenediamine, or arbitrary mixtures of such starter molecules. Alkylene oxides suitable for the alkoxylation are in particular ethylene oxide and/or propylene oxide, which can be used in the alkoxylation in any desired sequence or also in admixture.

It is also possible to use polyether polyol mixtures which contain at least one polyol having at least one tertiary amino group. Such polyether polyols containing tertiary amino groups can be prepared by alkoxylation of starter molecules or mixtures of starter molecules at least containing a starter molecule having at least 2 elemental hydrogen bonds reactive towards epoxides, of which at least one is an NH bond, or low molecular weight polyol compounds which carry tertiary amino groups. Examples of suitable starter molecules are ammonia, methylamine, ethylamine, n-propylamine, isopropylamine, ethanolamine, diethanolamine, triethanolamine, ethylenediamine, ethylenetriamine, triethanolamine, N-methyl-diethanolamine, ethylenediamine, N,N′-dimethyl-ethylenediamine, tetramethylenediamine, hexamethylenediamine, 2,4-toluoylenediamine, 2,6-toluoylenediamine, aniline, diphenylmethane-2,2′-diamine, diphenylmethane-2,4′-diamine, diphenylmethane-4,4′-diamine, 1-aminomethyl-3-amino-1,5,5-trimethylcyclohexane (isophoronediamine), dicyclohexylmethane-4,4′-diamine, xylylenediamine and polyoxyalkyleneamines.

It is also possible to use polyether polyols in which organic fillers are dispersed, such as, for example, addition products of toluoylene diisocyanate with hydrazine hydrate or copolymers of styrene and acrylonitrile.

The polytetramethylene ether glycols having molecular weights of from 400 g/mol to 4000 g/mol, obtainable by polymerisation of tetrahydrofuran, as well as hydroxyl-group-containing polybutadienes can also be used.

Hydroxyl polycarbonates are to be understood as being reaction products of glycols of the type ethylene glycol, diethylene glycol, 1,2-propylene glycol, 1,4-butanediol, neopentyl glycol or 1,6-hexanediol and/or triols, such as, for example, glycerol, trimethylolpropane, pentaerythritol or sorbitol, with diphenyl carbonate and/or dimethyl carbonate. The reaction is a condensation reaction in which phenol and/or methanol are cleaved. There are obtained, depending on the composition, liquid to wax-like, amorphous types having Tg values of >−40° C. or crystalline polycarbonate polyols having melting ranges from 40 to 90° C., whose molecular weight range is from 200 g/mol to 10,000 g/mol. Preference is given to those having a molecular weight range from 400 g/mol to 5000 g/mol, particularly preferably from 500 g/mol to 3000 g/mol.

Hydroxyl polyesters are to be understood as being reaction products of aliphatic, cycloaliphatic, aromatic and/or heterocyclic polybasic, but preferably dibasic, carboxylic acids, such as, for example, adipic acid, azelaic acid, sebacic and/or dodecanedioic acid, phthalic acid, isophthalic acid, succinic acid, suberic acid, trimellitic acid, phthalic anhydride, tetrahydrophthalic anhydride, glutaric anhydride, tetrachlorophthalic anhydride, endomethylenetetrahydrophthalic anhydride, maleic anhydride, maleic acid, fumaric acid, dimer and trimer fatty acids such as oleic acid, optionally in admixture with monomeric fatty acids, terephthalic acid dimethyl ester or terephthalic acid bis-glycol ester, ortho-, iso- or terephthalic acid, with polyhydric, preferably dihydric or trihydric, alcohols, such as, for example, ethylene glycol, diethylene glycol, triethylene glycol, tetraethylene glycol, 1,2-/1,3-propanediol and 1,4-/1,3-butanediol, 1,6-hexanediol, 1,8-octanediol, neopentyl glycol, 1,4-bis(hydroxymethyl)cyclohexane, bis(hydroxymethyl)tricyclo[5.2.1.0^{2.6}]decane or 1,4-bis(2-hydroxyethoxy)benzene, 2-methyl-1,3-propanediol, 2,2,4-trimethylpentanediol, 2-ethyl-1,3-hexanediol, dipropylene glycol, polypropylene glycols, dibutylene glycol, polybutylene glycols, 1,4-phenoldimethanol, bisphenol A, tetrabromobisphenol A, glycerol, trimethylolpropane, 1,2,6-hexanetriol, 1,2,4-butanetriol, pentaerythritol, quinitol, mannitol, sorbitol, methyl glycoside or 4,3,6-dianhydrohexite. Instead of the free polycarboxylic acids, the corresponding polycarboxylic anhydrides or corresponding polycarboxylic acid esters of lower alcohols, or mixtures thereof, can also be used concomitantly to prepare the polyester.

The reaction is a normal melt condensation, as is described in Ullmanns Enzyklopädie der technischen Chemie, “Polyester”, 4th Edition, Verlag Chemie, Weinheim, 1980.

There are obtained, depending on the composition, liquid, amorphous types having Tg values of >20° C. or crystalline polyester polyols having melting ranges from 40 to 90° C. The polyester polyols which can be used according to the invention have number-average molecular weights of from 500 g/mol to 2500 g/mol, preferably from 800 g/mol to 2000 g/mol.

Particular mention may be made here also of the products which are derived from reaction products of glycerol and hydroxyl fatty acids, in particular castor oil and its derivatives, such as, for example, monodehydrated castor oil.

Corresponding hydroxyl-group-terminated poly-ε-caprolactones can also be used.

In addition to the polyhydroxy compounds, polyether amines can also be used proportionately in component A. The same limits as already indicated for the polyether polyols apply in respect of the preferred molecular weights and composition of the mixture.

The above-mentioned isocyanate-reactive compounds can be reacted with any polyisocyanates, aromatic as well as aliphatic, before the actual prepolymerisation to give urethane-modified hydroxyl compounds.

As component B for the synthesis of an isocyanate-functional prepolymer there is used an excess of 2,4′-MDI or of a 2,4′-MDI-containing mixture of a plurality of polyisocyanates containing at least 50 wt. % 2,4′-MDI. There come into consideration as polyisocyanates which can be used in addition to 2,4′-MDI aromatic, aliphatic and cycloaliphatic diisocyanates as well as mixtures thereof. Suitable diisocyanates are compounds of the formula PIC(NCO)₂ having a mean molecular weight below 400 g/mol, wherein PIC denotes an aromatic C₆-C₁₅-hydrocarbon radical, an aliphatic C₄-C₁₂-hydrocarbon radical or a cycloaliphatic C₆-C₁₅-hydrocarbon radical, for example diisocyanates from the group butane diisocyanate, pentane diisocyanate, hexane diisocyanate (hexamethylene diisocyanate, HDI), 4-isocyanatomethyl-1,8-octane diisocyanate (triisocyanatononane, TIN), 4,4′-methylenebis(cyclohexyl isocyanate), 3,5,5-trimethyl-1-isocyanato-3-isocyanatomethylcyclohexane (isophorone diisocyanate, IPDI), 2,4- and/or 2,6-methylcyclohexyl diisocyanate (H₆TDI) as well as ω,ω′-diisocyanato-1,3-dimethylcyclohexane (H₆XDI), xylylene diisocyanate (XDI), 4,4′-diisocyanatodicyclohexylmethane, tetramethylene diisocyanate, 2-methylpentamethylene diisocyanate, 2,2,4-trimethylhexamethylene diisocyanate (THDI), dodecamethylene diisocyanate, 1,4-diisocyanatocyclohexane, 4,4′-diisocyanato-3,3′-dimethyl-dicyclohexylmethane, 4,4′-diisocyanatodicyclohexylpropane-(2,2), 3-isocyanatomethyl-1-methyl-1-isocyanatocyclohexane (MCI), 1,3-diisooctylcyanato-4-methyl-cyclohexane, 1,3-diisocyanato-2-methyl-cyclohexane and α,α,α′,α′-tetramethyl-m- or -p-xylylene diisocyanate (TMXDI), 2,4-/2,6-toluene diisocyanate (TDI), 2,2′-/4,4′-methylenediphenyl diisocyanate (MDI), naphthyl diisocyanate (NDI). Preference is given to the use of IPDI, HDI or TDI or MDI derivatives.

Also included is, of course, the use or concomitant use of the above-mentioned organic aliphatic, cycloaliphatic or heterocyclic polyisocyanates in the form of their derivatives, such as, for example, urethanes, biurets, allophanates, uretdiones, isocyanurates and trimerisates and mixed forms of those derivatives.

Isocyanate-reactive alkoxysilane compounds of the general formula (II) (component C) are sufficiently well known to the person skilled in the art. Examples which may be mentioned include aminopropyltrimethoxysilane, mercaptopropyltrimethoxysilane, aminopropylmethyldimethoxysilane, mercaptopropylmethyldimethoxysilane, aminopropyltriethoxysilane, mercaptopropyltriethoxysilane, aminopropylmethyldiethoxysilane, mercpatopropylmethyldiethoxysilane, aminomethyltrimethoxysilane, aminomethyltriethoxysilane, (aminomethyl)methyldimethoxysilane, (aminomethyl)methyldiethoxysilane, N-butyl-aminopropyltrimethoxysilane, N-ethyl-aminopropyltrimethoxysilane and N-phenyl-aminopropyltrimethoxysilane.

Further, the aspartic acid esters as described in EP-A 0 596 360 can also be used as isocyanate-reactive compounds. In those molecules of the general formula (III)

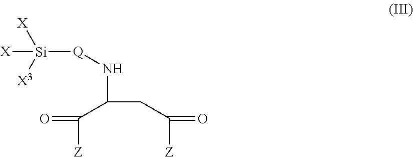

X denotes identical or different alkoxy or alkyl radicals, which can also be bridged, but wherein at least one alkoxy radical must be present on each Si atom, Q is a difunctional linear or branched aliphatic radical, and Z represents an alkoxy radical having from 1 to 10 carbon atoms. The use of such aspartic acid esters is preferred. Examples of particularly preferred aspartic acid esters are N-(3-triethoxysilylpropyl)aspartic acid diethyl ester, N-(3-trimethoxysilylpropyl)aspartic acid diethyl ester and N-(3-dimethoxymethylsilylpropyl)aspartic acid diethyl ester. The use of N-(3-trimethoxysilylpropyl)-aspartic acid diethyl ester is most particularly preferred.

The invention further provides a process for the preparation of polymers modified with alkoxysilane groups according to the above description, characterised in that isocyanate-reactive polymers A1 or optionally mixtures of such isocyanate-reactive polymers A1 with isocyanate-reactive polymers A2 (according to definition A with isocyanate-reactive groups present) are first reacted with an excess of polyisocyanate (component B) to give an isocyanate-functional prepolymer, which is subsequently masked by reaction with an isocyanate-reactive alkoxysilane compound (component C).

For the synthesis of an isocyanate-functional prepolymer, an excess of component B is used, there preferably being chosen an NCO:Y¹—H ratio of from 1.3:1.0 to 3.0:1.0, particularly preferably from 1.5:1.0 to 2.0:1.0 and most particularly preferably from 0.8:1.0 to 1.3:1.0.

The urethanisation can be accelerated by catalysis. Urethanisation catalysts known per se to the person skilled in the art, such as organotin compounds or amine catalysts, are suitable for accelerating the NCO—OH reaction. Examples of organotin compounds which may be mentioned include: dibutyltin diacetate, dibutyltin dilaurate, dioctyltin dilaurate, dibutyltin bis-acetoacetonate and tin carboxylates such as, for example, tin octoate. The mentioned tin catalysts can optionally be used in combination with amine catalysts such as aminosilanes or 1,4-diazabicyclo[2.2.2]octane.

Dibutyltin dilaurate is particularly preferably used as the urethanisation catalyst.

In the process according to the invention, the catalyst component, where used, is employed in amounts of from 0.001 wt. % to 5.0 wt. %, preferably from 0.001 wt. % to 0.1 wt. % and particularly preferably from 0.005 wt. % to 0.05 wt. %, based on the solids content of the process product.

The urethanisation of components A and B is carried out at temperatures of from 20° C. to 200° C., preferably from 40° C. to 140° C. and particularly preferably from 60° C. to 120° C.

The reaction is continued until complete conversion of the isocyanate-reactive groups is achieved. The progress of the reaction is expediently monitored by checking the NCO content and is complete when the corresponding theoretical NCO content is reached and is constant. This can be monitored by means of suitable measuring devices fitted in the reaction vessel and/or by analysis of removed samples. Suitable methods are known to the person skilled in the art. They are, for example, viscosity measurements, measurements of the NCO content, of the refractive index, of the OH content, gas chromatography (GC), nuclear magnetic resonance spectroscopy (NMR), infrared spectroscopy (IR) and near-infrared spectroscopy (NIR). The NCO content of the mixture is preferably determined by titrimetry.

It is immaterial whether the process according to the invention is carried out continuously, for example in a static mixer, extruder or kneader, or discontinuously, for example in a stirred reactor.

The process according to the invention is preferably carried out in a stirred reactor.

The further reaction with isocyanate-reactive alkoxysilanes (component C) is carried out within a temperature range of from 0° C. to 150° C., preferably from 20° C. to 120° C., the relative proportions generally being so chosen that from 0.8 to 1.3 mol of the isocyanate-reactive alkoxysilane compound is used per mol of NCO groups used.

In the case of the use of the isocyanate-reactive alkoxysilanes of formula (III), which is particularly preferred, a cyclocondensation can occur according to the teaching of EP-A 0 807 649, which can lower the viscosity of the prepolymers containing alkoxysilane groups according to the invention still further. Accordingly, in a preferred embodiment of the present invention, this hydantoin formation can also be effected deliberately.

The cyclocondensation can be effected simply by stirring the polyether-based polyurethane prepolymer, masked with an isocyanate-reactive alkoxysilane of formula (III), at temperatures of from 70° C. to 180° C., preferably from 80° C. to 150° C. The reaction can be carried out without further catalysis or, preferably, can be accelerated by catalysis. There come into consideration as catalysts both basic and acidic organic compounds, for example N,N,N,N-benzyltrimethylammonium hydroxide, other hydroxides soluble in organic media, DBN, DBU, other amidines, tin octoate, dibutyltin dilaurate, other organic tin compounds, tin octoate, acetic acid, other alkanoic acids, benzoic acid, benzoyl chloride, other acid chlorides, or dibutyl phosphate, or other derivatives of phosphoric acid. The catalyst is added in amounts of from 0.005 wt. % to 5 wt. %, preferably from 0.05 wt. % to 1 wt. %.

The invention further provides adhesives, coatings or foams based on the polyurethane prepolymers according to the invention. The adhesives, coatings or foams crosslink under the action of atmospheric moisture via a silanol polycondensation. Preference is given to the use of the prepolymers according to the invention in adhesives, particularly preferably in adhesives that exhibit a tensile-shear strength according to DIN EN 14293 of at least 5 N/mm², preferably of more than 6 N/mm², particularly preferably of more than 8 N/mm²

In order to produce such adhesives, coatings and foams, the polyurethane prepolymers containing alkoxysilane end groups according to the invention can be formulated by known processes together with conventional plasticisers, fillers, pigments, drying agents, additives, light stabilisers, antioxidants, thixotropic agents, catalysts, adhesion promoters and optionally further auxiliary substances and additives.

Typical adhesive and coating preparations according to the invention comprise, for example, from 10 wt. % to 100 wt. % of a polymer modified with alkoxysilane groups according to any one of claims 1 to 4 or of a mixture of two or more such polymers modified with alkoxysilane groups, up to 30 wt. % of a plasticiser or of a mixture of two or more plasticisers, up to 30 wt. % of a solvent or of a mixture of two or more solvents, up to 5 wt. % of a moisture stabiliser or of a mixture of two or more moisture stabilisers, up to 5 wt. % of a UV stabiliser or of a mixture of two or more UV stabilisers, up to 5 wt. % of a catalyst or of a mixture of two or more catalysts, and up to 80 wt. % of a filler or of a mixture of two or more fillers.

Examples of suitable fillers which may be mentioned include carbon black, precipitated silicas, pyrogenic silicas, mineral chalks and precipitated chalks. Examples of suitable plasticisers which may be mentioned include phthalic acid esters, adipic acid esters, alkylsulfonic acid esters of phenol, phosphoric acid esters and higher molecular weight polypropylene glycols.

Examples of thixotropic agents which may be mentioned include pyrogenic silicas, polyamides, hydrogenated castor oil secondary products and polyvinyl chloride.

Suitable catalysts for curing which can be used are any organometallic compounds and amine catalysts that are known to promote silane polycondensation. Particularly suitable organometallic compounds are in particular compounds of tin and titanium. Preferred tin compounds are, for example: dibutyltin diacetate, dibutyltin dilaurate, dioctyltin maleate and tin carboxylates such as, for example, tin(II) octoate or dibutyltin bis-acetoacetonate. The mentioned tin catalysts can optionally be used in combination with amine catalysts such as aminosilanes or 1,4-diazabicyclo[2.2.2]octane. Preferred titanium compounds are, for example, alkyl titanates, such as diisobutyl bis-acetoacetic acid ethyl ester titanate. For the use of amine catalysts alone there are suitable in particular those which have a particularly high base strength, such as amines having an amidine structure. Preferred amine catalysts are therefore, for example, 1,8-diazabicyclo[5.4.0]undec-7-ene or 1,5-diazabicyclo[4.3.0]non-5-ene.

There may be mentioned as drying agents in particular alkoxysilyl compounds, such as vinyltrimethoxysilane, methyltrimethoxysilane, isobutyltrimethoxysilane, hexadecyl-trimethoxysilane.

There are used as adhesion promoters the known functional silanes, such as, for example, aminosilanes of the above-mentioned type but also N-aminoethyl-3-aminopropyl-trimethoxy- and/or N-aminoethyl-3-aminopropyl-methyl-dimethoxysilane, epoxysilanes and/or mercaptosilanes.

The examples which follow illustrate the present invention without limiting it.

### EXAMPLES

Unless indicated otherwise, all percentages are by weight.

The NCO contents, in %, were determined by back-titration with 0.1 mol/l hydrochloric acid after reaction with butylamine, on the basis of DIN EN ISO 11909.

The viscosity measurements were carried out in accordance with ISO/DIS 3219:1990 at a constant temperature of 23° C. and a constant shear rate of 250/sec by means of a plate/cone rotary viscometer of the Physica MCR type (Anton Paar Germany GmbH, Ostfildern, DE) using measuring cone CP 25-1 (25 mm diameter, 1° cone angle).

The ambient temperature of 23° C. prevailing at the time of the tests is referred to as RT.

### Example 1

### According to the Invention

In a 1-litre sulfonation beaker with a lid, a stirrer, a thermometer and a nitrogen through-flow, a mixture of 833.4 g of polypropylene glycol having a hydroxyl number of 56 mg KOH/g and 0.07 g of dibutyltin dilaurate (Desmorapid® Z, Bayer MaterialScience AG, Leverkusen, DE) was heated to 40° C. 166.6 g of 2,4′-MDI (Desmodur® 24 M, Bayer MaterialScience AG, Leverkusen, DE) were then added, and prepolymerisation was carried out until the theoretical NCO content of 2.10% was reached. Then, at 40° C., 175.7 g of N-(3-trimethoxysilylpropyl)aspartic acid diethyl ester (prepared according to EP-A 596 360, Ex. 5) were added, and stirring was carried out until no further NCO content was detectable by titrimetry. The resulting polyurethane prepolymer having alkoxysilane end groups had a viscosity of 44,550 mPas (23° C.) and a number-average molecular weight of 4800 g/mol.

### Example 2

### According to the Invention

In a 1-litre sulfonation beaker with a lid, a stirrer, a thermometer and a nitrogen through-flow, 833.4 g of polypropylene glycol having a hydroxyl number of 56 mg KOH/g were heated to 60° C. 164.1 g of 2,4′-MDI (Desmodur® 24 M, Bayer MaterialScience AG, Leverkusen, DE) were then added, and prepolymerisation was carried out until the theoretical NCO content of 2.10% was reached. Then, at 60° C., 173.2 g of N-(3-trimethoxysilylpropyl)aspartic acid diethyl ester (prepared according to EP-A 0 596 360, Ex. 5) were added, and stirring was carried out until no further NCO content was detectable by titrimetry. The resulting polyurethane prepolymer having alkoxysilane end groups had a viscosity of 81,400 mPas (23° C.) and a number-average molecular weight of 5900 g/mol.

### Comparison Example 1

In a 1-litre sulfonation beaker with a lid, a stirrer, a thermometer and a nitrogen through-flow, a mixture of 881.9 g of polypropylene glycol having a hydroxyl number of 56 mg KOH/g and 0.07 g of dibutyltin dilaurate (Desmorapid® Z; Bayer MaterialScience AG, Leverkusen, DE) was heated to 60° C. 118.1 g of toluoylene diisocyanate (Desmodur® T 100, Bayer MaterialScience AG, Leverkusen, DE) were then added, and prepolymerisation was carried out until the theoretical NCO content of 2.07% was reached. Then, at 60° C., 173.2 g of N-(3-trimethoxysilylpropyl)aspartic acid diethyl ester (prepared according to EP-A 0 596 360, Ex. 5) were added, and stirring was carried out until no further NCO content was detectable by titrimetry. The resulting polyurethane prepolymer having alkoxysilane end groups had a viscosity of 70,930 mPas (23° C.) and a number-average molecular weight of 6200 g/mol.

### Comparison Example 2

In a 1-litre sulfonation beaker with a lid, a stirrer, a thermometer and a nitrogen through-flow, a mixture of 835.9 g of polypropylene glycol having a hydroxyl number of 56 mg KOH/g and 0.07 g of dibutyltin dilaurate (Desmorapid® Z; Bayer MaterialScience AG, Leverkusen, DE) was heated to 60° C. 164.1 g of MDI (Desmodur® 2460 M, Bayer MaterialScience AG, Leverkusen, DE) were then added, and prepolymerisation was carried out until the theoretical NCO content of 2.07% was reached. Then, at 60° C., 173.2 g of N-(3-trimethoxysilylpropyl)aspartic acid diethyl ester (prepared according to EP-A 0 596 360, Ex. 5) were added, and stirring was carried out until no further NCO content was detectable by titrimetry. The resulting polyurethane prepolymer having alkoxysilane end groups had a viscosity of 303,200 mPas (23° C.) and a number-average molecular weight of 5200 g/mol.

### Comparison Example 3

In a 1-litre sulfonation beaker with a lid, a stirrer, a thermometer and a nitrogen through-flow, a mixture of 745.9 g of polypropylene glycol having a hydroxyl number of 28 mg KOH/g and 0.07 g of dibutyltin dilaurate (Desmorapid® Z, Bayer MaterialScience AG, Leverkusen, DE) was heated to 60° C. 104.1 g of 2,4′-MDI (Desmodur® 24 M, Bayer MaterialScience AG, Leverkusen, DE) were then added, and prepolymerisation was carried out until the theoretical NCO content of 2.10% was reached. Then, at 60° C., 148.7 g of N-(3-trimethoxysilylpropyl)aspartic acid diethyl ester (prepared according to EP-A 0 596 360, Ex. 5) were added, and stirring was carried out until no further NCO content was detectable by titrimetry. The resulting polyurethane prepolymer having alkoxysilane end groups had a viscosity of 33,200 mPas (23° C.) and a number-average molecular weight of 5200 g/mol.

### Determination of the Skin Forming Time

By means of a knife (200 μm), a film is applied to a glass plate which has previously been cleaned with ethyl acetate, and the plate is immediately inserted into the Drying Recorder. The needle is loaded with 10 g and moves a distance of 35 cm over a period of 24 hours.

The Drying Recorder is located in a climatic chamber at 23° C. and 50% relative humidity.

The skin forming time is given as the time at which the permanent trace of the needle disappears from the film.

### Application Examples

In order to evaluate the application-related properties of the various polymers, they were processed in the following formulation:

| | Amount used |
|---|---|
| | in wt. % |
| Polymer | 46.06 |
| Filler (Socal ® U₁S₂) | 49.75 |
| Drying agent (Dynasylan ® VTMO) | 2.76 |
| Adhesion promoter (Dynasylan ® 1146) | 1.38 |
| Catalyst (Lupragen ® N700) | 0.05 |

In order to prepare the formulation, the filler (Socal® U1S2 from Solvay GmbH) and the drying agent (Dynasylan® VTMO; Evonik AG, Germany) are added to the polymer as binder and mixed at 3000 rpm in a vacuum dissolver with a wall scraper. The adhesion promoter (Dynasylan® 1146 from Evonik) is then added and stirred in at 1000 rpm in the course of 5 minutes. Lastly, the catalyst (Lupragen® N700 from BASF SE) is stirred in at 1000 rpm and, finally, air is removed from the finished mixture in vacuo.

In order to measure the physical properties, both membranes having a thickness of 2 mm and samples for determining the tensile-shear strength are prepared. The tensile-shear strength is measured using test specimens of oak, which are stored for 7 days at 23° C./50% relative humidity, then for 20 days at 40° C. and subsequently for one day at 23° C./50% relative humidity.

The hardness of the films is measured in accordance with DIN 53505 and the tensile-shear strength in accordance with DIN EN 14293.

The following table shows the results which were obtained:

| | Comp. 1 | Comp. 2 | Comp. 3 | Ex. 1 | Ex. 2 |
|---|---|---|---|---|---|
| Shore D hardness | 26 | 31 | 29 | 23 | 27 |
| Tensile-shear strength | 3.1 | 4.6 | 3.8 | 6.5 | 5.6 |
| [N/mm²] | | | | | |
| Skin forming time | 60 | 45 | 35 | 60 | 30 |
| [min] | | | | | |

1-10. (canceled)

11. A polymer modified with alkoxysilane groups, obtained by reacting
a) an isocyanate-functional prepolymer comprising structural units of formula (I) 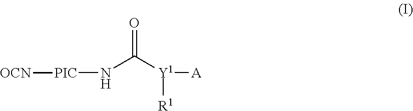
wherein
PIC is a radical, reduced by the isocyanate groups, of 2,4′-methylenediphenyl diisocyanate (2,4′-MDI) or of a combination of 2,4′-methylenediphenyl diisocyanate with another polyisocyanate, wherein the proportion of 2,4′-methylenediphenyl diisocyanate is at least 50 weight %, in each case based on the polyisocyanate component (component B),
Y¹ is nitrogen, oxygen or sulfur,
R¹ is either a free electron pair or hydrogen or any desired organic radical,
A is a radical, reduced by the isocyanate-reactive groups, of an isocyanate-reactive polymer comprising polyether polyols, polyester polyols, polycarbonate polyols or polytetrahydrofuran polyols which are linked together in any desired sequence via the structural element of the formula
—Y²—(C═O)—NH—PIC—NH—(C═O)—Y¹(R¹)—,
wherein Y¹ and Y², independently of one another, are nitrogen, oxygen or sulfur, derived from the polyisocyanates B, wherein optionally all or some of the terminal groups of those substructures are the corresponding thio compounds or amine derivatives, wherein
from 50 to 100 weight % are substructures A1 having a mean molecular weight (Mn) of from 200 g/mol to 2000 g/mol and
from 0 to 50 weight % are substructures A2 having a mean molecular weight (Mn) of more than 2000 g/mol,
wherein A overall has a mean functionality of from 2 to 4,
with
b) an isocyanate-reactive alkoxysilane compound (component C) of formula (II): 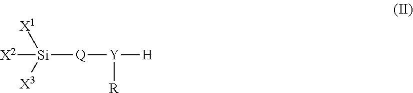
wherein
X¹, X² and X³
are, identically or differently, alkoxy or alkyl radicals, which are optionally bridged, with the proviso that at least one alkoxy radical must be present on each Si atom,
Q is a difunctional linear or branched aliphatic radical,
Y is nitrogen or sulfur,
R is either a free electron pair or hydrogen or any desired organic radical

12. The polymer modified with alkoxysilane groups of claim 11, wherein the proportion of 2,4′-methylenediphenyl diisocyanate is greater than 70 weight %, based on the polyisocyanate component.

13. The polymer modified with alkoxysilane groups of claim 11, wherein said polymer has a number-average molecular weight of less than 7000 g/mol.

14. The polymer modified with alkoxysilane groups of claim 11, wherein said polymer has a viscosity of less than 1000 Pas at 23° C.

15. A process for preparing the polymers modified with alkoxysilane groups of claim 11, wherein isocyanate-reactive polymers A1 or optionally mixtures of such isocyanate-reactive polymers A1 with isocyanate-reactive polymers A2 (according to definition A with isocyanate-reactive groups present) are first reacted with an excess of polyisocyanate (component B) to give an isocyanate-functional prepolymer, which is subsequently masked by reaction with an isocyanate-reactive alkoxysilane compound (component C).

16. The process of claim 15, wherein an excess of polyisocyanate in a ratio NCO to Y1-H of from 1.3:1.0 to 3.0:1.0 is used for the synthesis of the isocyanate-functional prepolymer.

17. The process of claim 15, wherein an excess of polyisocyanate in a ratio NCO to Y1-H of from 1.5:1.0 to 2.0:1.0 is used for the synthesis of the isocyanate-functional prepolymer.

18. The process of claim 15, wherein an excess of polyisocyanate in a ratio NCO to Y1-H of from 0.8:1.0 to 1.3:1.0 is used for the synthesis of the isocyanate-functional prepolymer.

19. An adhesive, coating, or foam comprising the polymer modified with alkoxysilane groups of claim 11.

20. An adhesive or coating preparation comprising
from 10 weight % to 100 weight % of at least one polymer modified with alkoxysilane groups of claim 11;
from 0 weight % to 30 weight % of a plasticiser or of a mixture of two or more plasticisers;
from 0 weight % to 30 weight % of a solvent or of a mixture of two or more solvents;
from 0 weight % to 5 weight % of a moisture stabiliser or of a mixture of two or more moisture stabilisers;
from 0 weight % to 5 weight % of a UV stabiliser or of a mixture of two or more UV stabilisers;
from 0 weight % to 5 weight % of a catalyst or of a mixture of two or more catalysts;
from 0 weight % to 80 weight % of a filler or of a mixture of two or more fillers;
wherein the sum of the amounts of the components totals 100 weight %.

21. The polymer modified with alkoxysilane groups of claim 11, wherein the proportion of 2,4′-methylenediphenyl diisocyanate is greater than 90 weight %, based on the polyisocyanate component.

22. The polymer modified with alkoxysilane groups of claim 11, wherein said polymer has a number-average molecular weight of less than 5000 g/mol.

23. The polymer modified with alkoxysilane groups of claim 11, wherein said polymer has a viscosity of less than 500 Pas at 23° C.

24. The polymer modified with alkoxysilane groups of claim 11, wherein said polymer has a viscosity of less than 100 Pas at 23° C.
